(19) United States
(12) Patent Application Publication
(10) Pub. No.: US 2016/0147646 A1
(43) Pub. Date: May 26, 2016

(54) METHOD AND SYSTEM FOR EXECUTING AUTOMATED TESTS IN AN INTEGRATED TEST ENVIRONMENT

(71) Applicant: Wipro Limited, Bangalore (IN)

(72) Inventors: Girish Raghavan, Chennai (IN); Ganesh Narayan, Bangalore (IN); Thamilchelvi Peterbarnabas, Chennai (IN)

(21) Appl. No.: 14/618,550

(22) Filed: Feb. 10, 2015

(30) Foreign Application Priority Data
Nov. 21, 2014 (IN) 5839/CHE/2014

(51) Int. Cl. G06F 11/36

(52) U.S. Cl. CPC G06F 11/3688; G06F 11/3664; G06F 11/3684

(57) ABSTRACT

This technology relates to a method and system for executing automated tests in an integrated test environment comprising plurality of test environments. The test management module configured in the system creates one or more test sets by grouping the one or more test cases received from the input module. The control module determines status of the test environment for executing each test set. If the test environment is available then the corresponding test set is executed and if the test environment is not available an order of execution of the test sets is rearranged. The status of the test environment is checked after a predetermined time interval and if the test environment is not available, the control module determines the availability of the virtual response for providing virtual service. If the test environment is not available the control module creates a ticket indicating failure of the test environment.

This application claims the benefit of Indian Patent Application No. 5839/CHE/2014 filed Nov. 21, 2014, which is hereby incorporated by reference in its entirety.

### FIELD

This technology is related, in general to software testing, and more particularly, but not exclusively to a method and system for executing automated tests in an integrated test environment.

### BACKGROUND

The lifecycle of the software development begins with coding of the application and then proceeds with iterative testing and modification cycles to ensure the integrity of the code. Finally, the execution of the completed code can be analyzed to facilitate further revision of the code to improve the performance of the code.

Traditional testing of the code involves external monitoring of the integrity of the code and the performance of the code. The integrity of the code is monitored in order to ensure the proper operation of the code logic. The performance of the code involves monitoring of the code through software testing tools which is known in the art.

For testing an application, the testing personnel must establish and configure a testing environment. In large enterprise systems, testing is carried out in a complex environment across multiple systems. Due to the multiple systems involved in the execution process, there is unpredictability in the availability of the environment and inability to analyze environment availability for testing the code. Because of the above problems, the automation tests cannot be executed without any interruption.

An existing test automation technique discloses the aspect of executing the automation tests in multiple environments using a test automation controller which leads to a tedious as well as time consuming software testing and automation process. Also, the existing technique may not be able to address the issue of providing un-interrupted automated tests across multiple systems.

### SUMMARY

A method for executing automated tests in an integrated test environment comprising a plurality of test environments includes receiving one or more test cases from a test management system. Upon receiving the one or more test cases, the one or more test sets are created by grouping the one or more test cases.

The method further comprises determining a status of each of the plurality of test environments needed for executing each of the one or more test sets. Upon determining the status of each of the plurality of test environments, an order of execution of each of the one or more test sets is rearranged based on the status of each of the plurality of test environments.

A test execution computing apparatus that is configured to be capable of executings an automated test run in an integrated test environment. The test execution computing apparatus comprises a test set management module and a control module. The test set management module receives one or more test cases from a test management system and creates one or more test sets for the automated tests by grouping the one or more test cases. The control module determines the status of each of the plurality of test environments needed for executing each of the one or more test sets. Thereafter, the control module rearranges an order of execution of each of the one or more test sets based on the status of each of the plurality of test environments.

A non-transitory computer readable medium including operations stored thereon that when processed by at least one processor cause a system to perform the acts of receiving one or more test cases from a test management system and creating the one or more test sets by grouping the one or more test cases. The processing unit further causes the system to determine the status of each of the plurality of test environments needed for executing each of the one or more test sets and rearranges an order of execution of each of the one or more test sets based on the status of each of the plurality of test environments.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a illustrates system architecture for executing automated tests in an integrated test environment in accordance with some embodiments of the present disclosure;

FIG. 1b illustrates a block diagram of a test execution computing apparatus in accordance with some embodiments of the present disclosure;

FIG. 1c illustrates an exemplary representation of an interface of the test execution computing apparatus in accordance with some embodiments of the present disclosure;

FIGS. 2a-2c illustrates an exemplary representation for executing test sets in accordance with some embodiments of the present disclosure;

FIG. 3 shows a flowchart illustrating a method for executing automated tests in an integrated test environment in accordance with some embodiments of the present disclosure;

FIG. 4 shows a flowchart illustrating a method for determining availability of the test environment for execution of the automated tests in accordance with some embodiments of the present disclosure;

FIG. 5 shows a flowchart illustrating a method for determining availability of a solution for recovery of the test environment in accordance with some embodiments of the present disclosure; and

FIG. 6 illustrates a block diagram of an example of a test execution computing apparatus that may be configured to be capable of implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

As used herein, the term “test environment” refers to a setup of software and hardware on which the testing of software product is performed, the term “automated instructions” refers to automated test scripts running on a test environment and the term “integrated test environment” refers to plurality of test environments over multiple systems.

Accordingly, the present disclosure relates to a method and system for executing automated tests in an integrated test environment. A test set management module configured in the system receives one or more test cases from a test management system. The test set management module creates one or more test sets of automated test cases. A control module configured in the system requests for the status of the environment for executing each test set from an environment status module configured in the system. The environment status module continuously monitors the availability of the test environment and provides periodic update to a control module of the environment status. The control module executes the test set upon identifying the availability of at least one test environment corresponding to the test set. The control module rearranges an order of execution of the test set based on the status of each of the plurality of test environment.

The control module checks for availability of the test environment after a predefined time interval. If the test environment is available the control module executes the test set. If the test environment is not available, the control module checks for the availability of the virtual response for the test set. If the virtual response is available, the virtual service is provided for executing the test set. If the virtual response is not available, a ticket is created using the ticketing module. The ticket indicates failure of the test environment.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

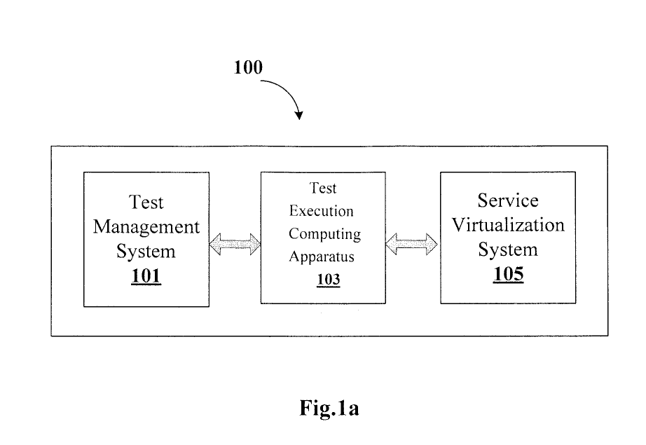

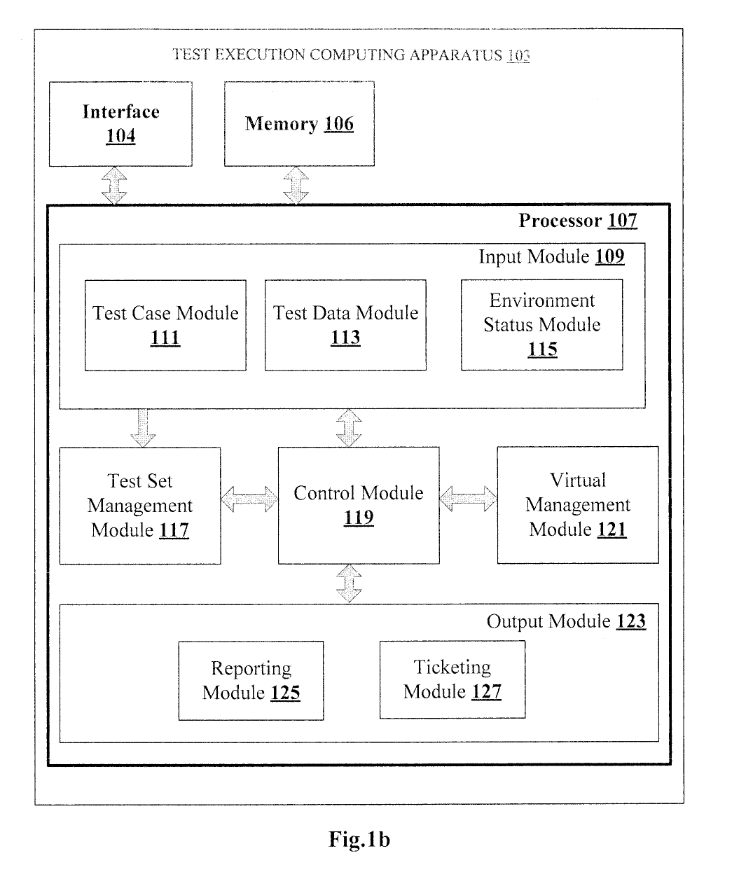

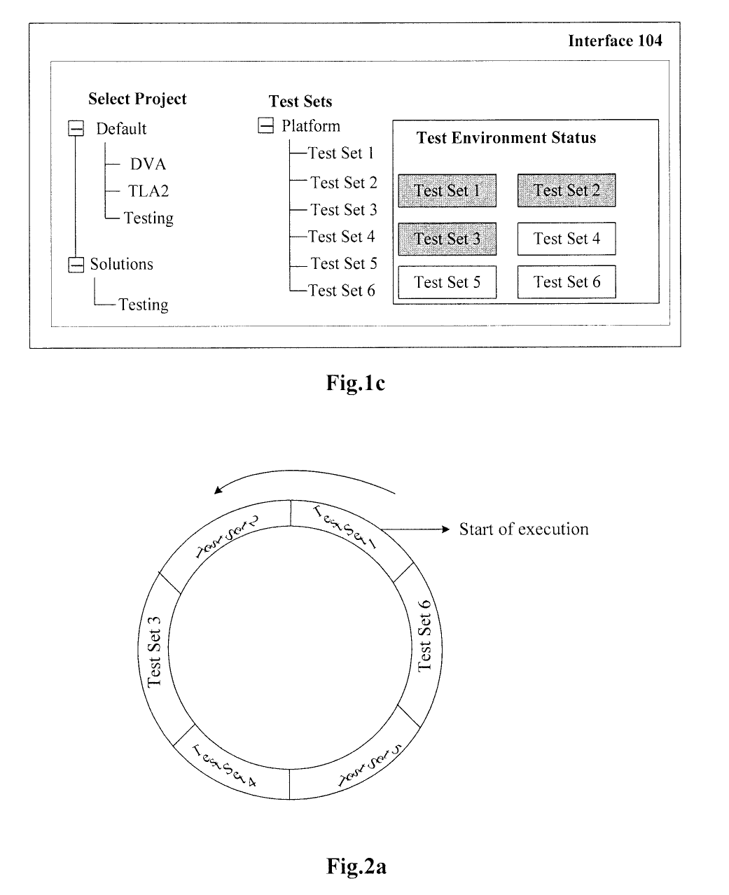

FIG. 1a illustrates system architecture for executing automated tests in an integrated test environment in accordance with some embodiments of the present disclosure.

As shown in FIG. 1a, the system architecture 100 may include a test management system 101, a test execution computing apparatus 103 and a service virtualization system 105. In an embodiment, the test management system 101 is used for storing one or more test cases. The one or more test cases comprise a set of conditions or variables for testing the functionality of a particular application or a software system. The one or more test cases are executed in a test environment for testing the correct functionality of the application or the software system (In other words to check whether the application or the software system functions as expected). The test management system 101 is also configured to store the results of the executed one or more test cases. The test management system 101 is an external module which is interfaced with the test execution computing apparatus 103. The test execution computing apparatus 103 is configured to execute the one or more test cases associated with an application or a software system. The test management system 101 provides the one or more test cases based on the software system being executed in the test execution computing apparatus 103. The service virtualization system 105 is used for recording virtualized responses for the one or more test cases and enabling the usage of the virtual responses while executing the one or more test cases.

FIG. 1b illustrates a block diagram of an example of the test execution computing apparatus 103 in accordance with some embodiments of the present disclosure.

As shown in FIG. 1b, the test execution computing apparatus 103 may comprise an interface 104, a memory 106 and a processor 107. The interface 104 may include a variety of software and hardware interfaces, for example, a web interface, a graphical user interface, etc. The interface 104 is coupled with the processor 107 and an Input/Output (I/O) device. The I/O device is configured to receive inputs from user via the interface 104 and transmit outputs for displaying in the I/O device via the interface 104.

In one implementation, the test execution computing apparatus 103 may store data in the memory 106. The data may include, for example, the data associated with one or more test cases, data associated with test environment for executing each test case, results of each of the one or more test cases and other data. In one embodiment, the data may be stored in the memory 106 in the form of various data structures. Additionally, the aforementioned data can be organized using data models, such as relational or hierarchical data models. The other data may be used to store data, including temporary data and temporary files, generated by modules in the processor 107 for performing the various functions of the test execution computing apparatus 103.

The processor 107 includes input module 109, a test set management module 117, a control module 119, a virtual management module 121 and an output module 123. The input module 109 comprises a test case module 111, a test data module 113 and an environment status module 115. The output module 123 comprises a reporting module 125 and a ticketing module 127.

In one implementation, the test execution computing apparatus 103 is connected to the test management system 101. The test case module 111 retrieves the one or more test cases from the test management system 101 for testing any application or a software system. Thereafter, the test case module 111 provides the one or more test cases to the test set management module 117. The test data module 113 retrieves test data necessary for executing each of the one or more test cases and provides the test data to the test set management module 117.

The test set management module 117 creates one or more test sets for the automation run by grouping the one or more test cases. The test management module 117 creates one or more test sets upon receiving the one or more test cases from the test case module 111 and test data from the test data module 113. The one or more test cases are grouped based on one or more parameters like the environment to which the test cases belong for example, test environment and production environment, the system with which the test cases are associated with and the technology landscape. The test environment is a system where test execution occurs. As an example, the test environment is a server in which the system under test is configured. FIG. 1c illustrates exemplary representation of the interface of the test execution computing apparatus 103. As shown in FIG. 1c, the interface may include parameters namely one or more projects, one or more test sets and the test environment status of each test set. In one example, the project names are “Default” and “Solutions”. The user may select the project namely “default” for testing. The one or more test sets associated with the project “default” are test set 1, test set 2, test set 3, test set 4, test set 5 and test set 6. The test environment status shows that the test environment corresponding to the test set 1, test set 2 and test set 3 are available and the test environment corresponding to the test set 4, test set 5 and test set 6 are not available. In an embodiment, the user may assign a unique test set name for each of the test set created for identification of the test set. The created one or more test sets are updated in the test management system 101 either by a manual invoked process or automatically.

The environment status module 115 is configured to provide periodic update on the status of the test environment for executing the one or more test cases.

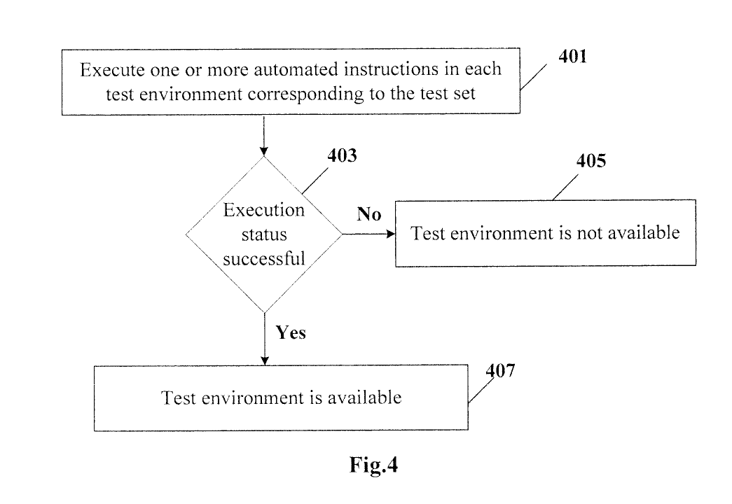

The control module 119 is configured to determine the status of the test environment for executing each of the one or more test sets. The control module 119 sends a request to the environment status module 115 to identify the availability of at least one test environment corresponding to the test set. If the test environment is available, the control module 119 executes the test set. If the test environment is not available, the control module 119 rearranges the order of execution of each test case based on the status of the test environment. In an embodiment, the order of execution is rearranged based on the predefined order. The predefined order is set by the user of the test execution computing apparatus 103. The method of determining the status of the test environment is illustrated in FIG. 4.

In an embodiment, the control module 119 determines the status of the test environment after a predetermined time interval. If the test environment is available, the control module 119 executes the test set. If the test environment is not available, the control module 119 determines the availability of virtual service for executing the test set. The control module 119 interacts with the virtual management module 121 to identify the availability of the virtual response for each test set. In one implementation, the virtual management module 121 retrieves information of the availability of the virtual response for each test set from the service virtualization system 105.

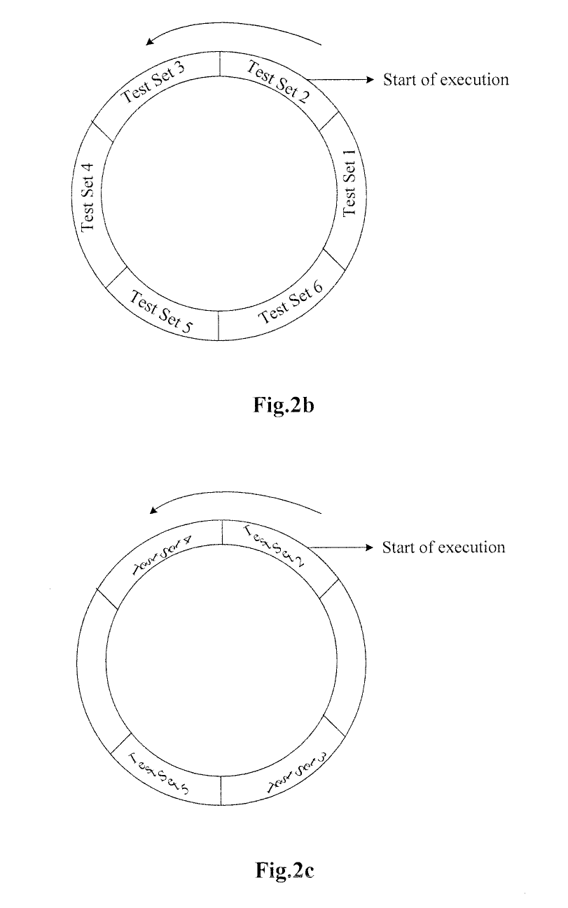

FIGS. 2a-2c illustrates an example of a method for executing test sets in accordance with some embodiments of the present disclosure.

In an exemplary embodiment, the one or more test sets associated with a marketing system of a particular project are test set 1, test set 2, test set 3, test set 4, test set 5 and test set 6. As shown in FIG. 2a, the one or more test sets are arranged in the circular queue form. In an embodiment, the one or more test cases may be arranged in one or more forms like parallel form etc. The control module 119 determines the availability of the test environment associated with the test set 1. In the alternative, if the test environment is available the control module 119 executes the test set 1 in the test environment. If the test environment is not available, the order of execution of the test sets are rearranged such that, for example, the test set 1 is placed at the end of the circular queue. The control module 119 determines that the test environment for executing the test set 1 is not available. Therefore, the control module 119 provides lowest order of execution for the test set 1 and places the test set 1 at the end of the circular queue as shown in FIG. 2b. Then, the control module 119 determines the status of the test environment for executing the test set 2. The control module 119 determines that the test environment for executing the test set 2 is available. Therefore, the control module provides highest order of execution for the test set 2 and test set 2 is executed. Further, the control module 119 determines that the test environment corresponding to the test set 4 and test set 6 are available. Therefore, the test set 4 and test set 6 are executed. The control module 119 determines that test environment corresponding to the test set 3 and test 5 is not available. Therefore, the control module 119 provides lowest order of execution to the test 3 and test set 5. The test set 3 and test 5 are placed at the end of the circular queue as shown in FIG. 2c. The control module 119 determines the status of the test environment corresponding to the test set 1 after a predetermined time interval. The control module 119 identifies that the test environment corresponding to the test set 1 is available and therefore executes the test set 1 in the test environment. Then the control module 119 determines the status of the test environment corresponding to the test set 3. The control module 119 identifies that the test environment corresponding to the test set 3 is not available. Therefore, the control module 119 determines the availability of the virtual response for executing the test set 3. The control module 119 identifies the availability of the virtual response for the test set 3 and therefore provides the virtual service for executing the test set 3. Thereafter, the control module 119 determines the availability of the test environment corresponding to the test set 5. The control module 119 identifies non-availability of the test environment corresponding to the test 5. Upon determining non-availability of the test environment corresponding to the test set 5, the control module 119 determines the failure of the test environment. The control module 119 identifies non-availability of the virtual response for executing the test set 5. Therefore, the control module 119 creates a ticket for indicating failure of the test environment corresponding to the test set 5. The control module 119 creates an activity report on the status of the test environment corresponding to each of the test sets using the reporting module 125.

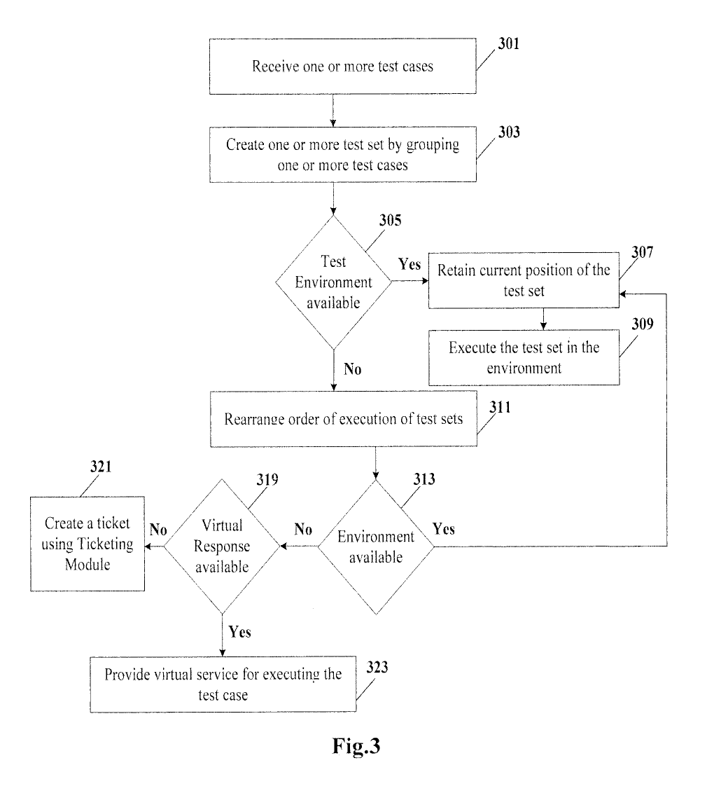

FIG. 3 illustrates a method of executing automated tests in an integrated test environment in accordance with an embodiment of the present disclosure.

FIG. 4 illustrates a method for determining availability of the test environment for execution of the automated tests in accordance with some embodiments of the present disclosure.

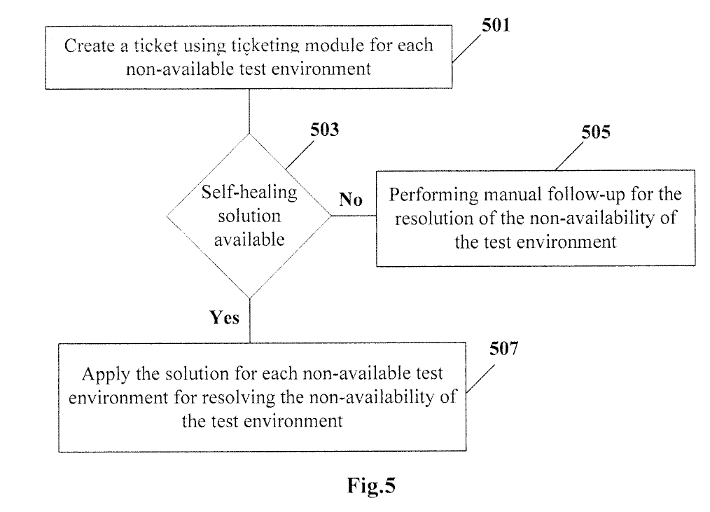

FIG. 5 shows a flowchart illustrating a method for determining availability of a solution for recovery of the test environment in accordance with some embodiments of the present disclosure.

The order in which the methods as described in FIGS. 3-5 is not intended to be construed as a limitation, and any number of the described method blocks can be combined in any order to implement the method. Additionally, individual blocks may be deleted from the method without departing from the spirit and scope of the subject matter described herein. Furthermore, the method can be implemented in any suitable hardware, software, firmware, or combination thereof.

As illustrated in FIG. 3, the method comprises one or more blocks for executing automated tests in an integrated test environment. The method may be described in the general context of computer executable instructions. Generally, computer executable instructions can include routines, programs, objects, components, data structures, procedures, modules, and functions, which perform particular functions or implement particular abstract data types.

At block 301, the one or more test cases are received. In an embodiment, the test set management module 117 of the test execution computing apparatus 103 receives one or more test cases from the test case module 111. The test set management module 117 also receives the data required for executing each of the one or more test cases from the test data module 113. The test case module 111 retrieves the one or more test cases from the test management system 101 and the test data module 113 retrieves data for executing each of the one or more test cases from the test management system 101.

At block 303, the one or more test sets are created. The test set management module 117 creates one or more test sets by grouping the one or more test cases upon receiving the one or more test cases. Each of the one or more test sets is associated with a test environment for executing the test set. In an embodiment, each of the one or more test sets are positioned in an order which includes but not limited to a circular queue. The test set management module 117 updates the test management system 101 with the created one or more test sets.

At block 305, the status of the test environment is determined. The control module 119 of the test execution computing apparatus 103 determines the status of the test environment corresponding to each of the one or more test sets. If the test environment corresponding to test set is available, the control module 119 proceeds to block 307 via “Yes”. If the test environment corresponding to the test set is not available, the control module 119 proceeds to block 311 via “No”.

At block 307, the control module 119 retains the position of the test set in the circular queue. In an embodiment, upon determining the test environment to be available, the position of the test set in the circular queue is retained.

At block 309, the test set is executed. The control module 119 executes the test set in the corresponding test environment.

At block 311, the order of execution of the test sets are rearranged. In an embodiment, the control module 119 rearranges the order of execution of the test set upon determining non-availability of the test environment for executing the test set.

At block 313, the status of the test environment is determined after a predetermined time interval. The control module 119 determines the status of the each of the plurality of test environments after the predetermined time interval. If the test environment corresponding to test set is available, the method proceeds to block 307 via “Yes”. If the test environment corresponding to the test set is not available, the method proceeds to block 319 via “No”.

At block 319, the control module 119 determines the status of virtual response. In an embodiment, the control module 119 determines the status of virtual response for the test set. If the virtual response is available for the test set, the method proceeds to block 323 via “Yes”. If the virtual response is not available for the test set, the method proceeds to block 321 via “No”.

At block 323, the virtual service is provided for execution of the test set. The control module provides the virtual service for executing the test set.

At block 321, the control module 119 creates a ticket using a ticketing module. The control module creates a ticket for one or more test sets for which the virtual response is not available. The ticket indicates failure of the one or more test environments.

As illustrated in FIG. 4, the method comprises one or more blocks for determining availability of the test environment for executing the automated tests. The method may be described in the general context of computer executable instructions. Generally, computer executable instructions can include routines, programs, objects, components, data structures, procedures, modules, and functions, which perform particular functions or implement particular abstract data types.

At block 401, the one or more automated instructions are executed in each of the test environment in an automated manner. In an embodiment, the control module 119 executes each of the one or more automated instructions in each of the plurality of test environments.

At block 403, the execution status of each of the one or more automated instructions is determined. The environment status module 115 determines the execution status of each of the one or more automated instructions. If the execution status is successful i.e if all the one or more automated instructions execute successfully in the test environment then the method proceeds to block 407 via “Yes”.

If the execution status is failure i.e if one or more automated instructions do not execute in the test environment then the method proceeds to block 405 via “No”.

At block 407, the test environment status is determined as available. The environment status module 115 monitors the execution status of the automated instructions in the test environment and determines the status of the test environment as available.

At block 409, the test environment status is determined as not available. The environment status module 115 monitors the execution status of the automated instructions in the test environment and determines the status of the test environment as not available.

As illustrated in FIG. 5, the method comprises one or more blocks for determining availability of a solution for recovery of the test environment. The method may be described in the general context of computer executable instructions. Generally, computer executable instructions can include routines, programs, objects, components, data structures, procedures, modules, and functions, which perform particular functions or implement particular abstract data types.

At block 501, the ticketing module in the test execution computing apparatus creates a ticket upon identifying non-availability of the test environment. The control module determines non-availability of the test environment for the one or more test environments. Therefore, the ticketing module creates a ticket for each of the one or more non available test environments. The ticket indicates failure of the test environment.

At block 503, the availability of the solution for recovery of the test environment is determined. If the self-healing solution is available for the test environment, then the method proceeds to block 507 via “yes”. If the self-healing solution is not available for the test environment then the method proceeds to block 505 via “No”.

At block 505, the manual follow-up is performed for the resolution of each of the test environment which is in non-availability state. In the manual follow-up, the test environment is recovered from failure by the relevant technical personnel by manual intervention.

At block 507, the self-healing solution is provided for each test environment which is in non-availability state for recovery of each of the test environment.

The order in which the method is described is not intended to be construed as a limitation, and any number of the described method blocks can be combined in any order to implement the method. Additionally, individual blocks may be deleted from the method without departing from the spirit and scope of the subject matter described herein. Furthermore, the method can be implemented in any suitable hardware, software, firmware, or combination thereof.

Test Execution Computing Apparatus

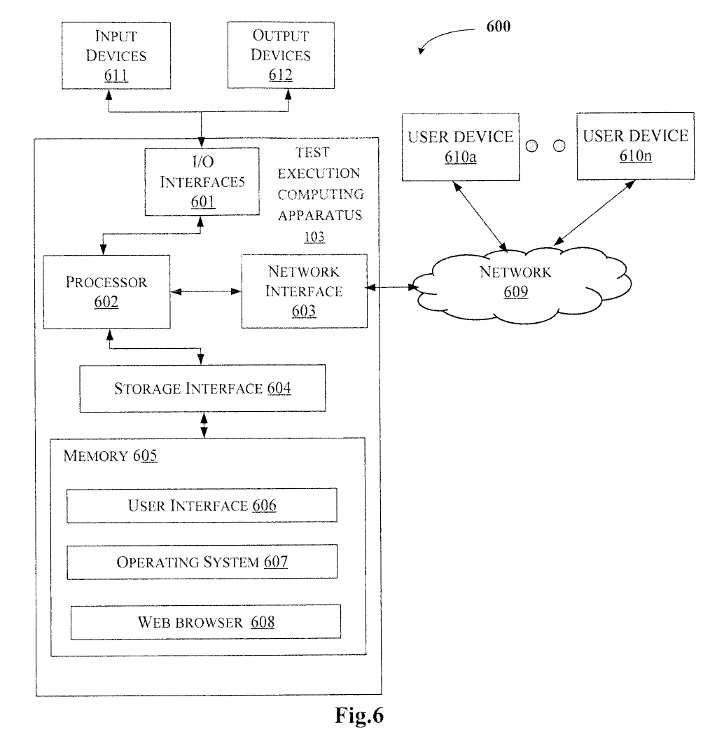

FIG. 6 illustrates a block diagram of an exemplary test execution computing apparatus 103 for implementing embodiments consistent with the present invention. In an embodiment, the test execution computing apparatus 103 is used to execute automated test runs in an integrated test environment. The test execution computing apparatus 103 may comprise a central processing unit (“CPU” or “processor”) 602. The processor 602 may comprise at least one data processor for executing program components for executing user- or system-generated business processes. A user may include a person, a person using a device such as such as those included in this invention, or such a device itself. The processor 602 may include specialized processing units such as integrated system (bus) controllers, memory management control units, floating point units, graphics processing units, digital signal processing units, etc.

The processor 602 may be disposed in communication with one or more input/output (I/O) devices (611 and 612) via I/O interface 601. The I/O interface 601 may employ communication protocols/methods such as, without limitation, audio, analog, digital, stereo, IEEE-1394, serial bus, universal serial bus (USB), infrared, PS/2, BNC, coaxial, component, composite, digital visual interface (DVI), high-definition multimedia interface (HDMI), Radio Frequency (RF) antennas, S-Video, Video Graphics Array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the test execution computing apparatus 103 may communicate with one or more I/O devices (611 and 612).

In some embodiments, the processor 602 may be disposed in communication with a communication network 609 via a network interface 603. The network interface 603 may communicate with the communication network 609. The network interface 603 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 603 and the communication network 609, the test execution computing apparatus 103 may communicate with one or more user devices 610 (a, . . . ,n). The communication network 609 can be implemented as one of the different types of networks, such as intranet or Local Area Network (LAN) and such within the organization. The communication network 609 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 609 may include a variety of network devices, including routers, bridges, servers, computing devices, storage devices, etc. The one or more user devices 610 (a, . . . ,n) may include, without limitation, personal computer(s), mobile devices such as cellular telephones, smartphones, tablet computers, eBook readers, laptop computers, notebooks, gaming consoles, or the like.

In some embodiments, the processor 602 may be disposed in communication with a memory 605 (e.g., RAM, ROM, etc. not shown in FIG. 6) via a storage interface 604. The storage interface 604 may connect to memory 605 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, user interface application 606, an operating system 607, web server 608 etc. In some embodiments, test execution computing apparatus 103 may store user/application data 606, such as the data, variables, records, etc. as described in this invention. Such databases may be implemented as fault-tolerant, relational, scalable, secure databases such as Oracle or Sybase.

The operating system 607 may facilitate resource management and operation of the test execution computing apparatus 103. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 606 may facilitate display, execution, interaction, manipulation, or operation of program components through textual or graphical facilities. For example, user interfaces may provide computer interaction interface elements on a display system operatively connected to the test execution computing apparatus 103, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the test execution computing apparatus 103 may implement a web browser 608 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the test execution computing apparatus 103 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft.NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the test execution computing apparatus 103 may implement a mail client stored program component. The mail client may be a mail viewing application, such as Apple Mail, Microsoft Entourage, Microsoft Outlook, Mozilla Thunderbird, etc.

Furthermore, one or more non-transitory computer-readable storage media may be utilized in implementing embodiments consistent with the present invention. A non-transitory computer-readable storage medium refers to any type of physical memory on which information or data readable by a processor may be stored. Thus, a non-transitory computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Additionally, advantages of present invention are illustrated herein.

Embodiments of the present disclosure enables creation of test set groups for overnight automation runs across multiple environments.

The embodiments of the present disclosure provide a method determining availability of the test environment before running each test set.

The embodiments of the present disclosure provide a virtual service for executing the test sets upon identifying non availability of the test environment.

The embodiments of the present invention provide a method for creating a ticket indicating failure of the testing environment.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required.

On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for executing automated tests in an integrated test environment comprising a plurality of test environments, the method comprising:
receiving, by a test execution computing apparatus, one or more test cases from a test management system;
creating, by the test execution computing apparatus, one or more test sets by grouping the one or more test cases;
determining, by the test execution computing apparatus, a status of each of the plurality of test environments needed for executing each of the one or more test sets; and
rearranging, by the test execution computing apparatus, an order of execution of each of the one or more test sets based on the status of each of the plurality of test environments.

2. The method of claim 1 further comprising executing, by the test execution computing apparatus, each of the one or more test sets based on the order of execution.

3. The method of claim 1 further comprising:
determining, by the test execution computing apparatus, availability of a virtual response for each of the one or more test sets upon determining non-availability of the test environment for executing each of the one or more test sets; and
providing, by the test execution computing apparatus, a virtual service for executing each of the one or more test sets based on the availability of the virtual response.

4. The method of claim 1, wherein the status of each of the plurality of test environments is one of availability and non-availability.

5. The method of claim 1, wherein the determining the status of each of the plurality of test environments further comprises:
executing, by the test execution computing apparatus, one or more automated instructions in at least one of the plurality of test environments corresponding to each of the one or more test sets; and
determining, by the test execution computing apparatus, an execution status of each of the one or more automated instructions based on the execution of the one or more automated instructions, wherein the execution status is one of success and failure.

6. The method of claim 1, wherein the rearranging the order of execution of each of the one or more test sets comprises:
providing, by the test execution computing apparatus, highest order of execution for one of the one or more test sets upon determining availability of corresponding test environment; and
providing, by the test execution computing apparatus, lowest order of execution for one of the one or more test sets upon determining non-availability of corresponding test environment.

7. The method of claim 6, wherein the one or more test sets are executed in circular queue order in which highest order test set is placed at beginning of the circular queue and lowest order test set is placed at end of the circular queue.

8. The method of claim 1, wherein the rearranging the order of execution is based on the status of each of the plurality of test environments and a predefined order.

9. The method of claim 1, wherein the determining the status of each of the plurality of test environments further comprises:
identifying, by the test execution computing apparatus, the status of each of the plurality of test environments after a predefined interval of time; and
re-arranging, by the test execution computing apparatus, the order of execution based on the identified status of each of the plurality of test environments after the predefined interval of time.

10. A test execution computing apparatus comprising:
at least one at least one processor; and
at least one memory coupled to the processor which is configured to be capable of executing programmed instructions comprising and stored in the memory to:
receive one or more test cases from a test management system;
create one or more test sets for the automated tests by grouping the one or more test cases;
determine a status of each of the plurality of test environments needed for executing each of the one or more test sets; and
rearrange an order of execution of each of the one or more test sets based on the status of each of the plurality of test environments;

11. The test execution computing apparatus of claim 10, wherein the processor coupled to the memory is further configured to be capable of executing programmed instructions for the determine the status of each of the plurality of test environments further comprising at least one additional programmed instruction to:
execute one or more automated instructions in at least one of the plurality of test environments corresponding to each of the one or more test sets; and
determine an execution status of each of the one or more automated instructions based on the execution of the one or more automated instructions, wherein the execution status is one of success and failure.

12. The test execution computing apparatus of claim 10, wherein the processor coupled to the memory is further configured to be capable of executing programmed instructions for the determine the status of each of the plurality of test environments further comprising at least one additional programmed instruction to:
identify the status of each of the plurality of test environments after a predefined interval of time; and
re-arrange the order of execution based on the identified status of each of the plurality of test environments after the predefined interval of time.

13. The test execution computing apparatus of claim 10, wherein the processor coupled to the memory is further configured to be capable of executing programmed instructions comprising at least one additional programmed instruction to:
determine availability of a virtual response for each of the one or more test sets upon determining non-availability of the test environment for executing each of the one or more test sets; and
provide a virtual service for executing each of the one or more test sets based on the availability of the virtual response.

14. The test execution computing apparatus of claim 10, wherein the processor coupled to the memory is further configured to be capable of executing programmed instructions for the rearrange the order of execution of each of the one or more test sets further comprising at least one additional programmed instruction to:
provide highest order of execution for one of the one or more test sets upon determining availability of corresponding test environment; and
provide lowest order of execution for one of the one or more test sets upon determining non-availability of corresponding test environment.

15. The test execution computing apparatus of claim 14, wherein the processor coupled to the memory is further configured to be capable of executing programmed instructions comprising at least one additional programmed instruction to:
execute the one or more test sets in circular queue order in which highest order test set is placed at beginning of the circular queue and lowest order test set is placed at end of the circular queue.

16. The test execution computing apparatus of claim 10, wherein the processor coupled to the memory is further configured to be capable of executing programmed instructions comprising at least one additional programmed instruction to:
rearrange the order of execution based on the status of each of the plurality of test environments and a predefined order.

17. A non-transitory computer readable medium having stored thereon instructions for executing automated tests in an integrated test environment comprising a plurality of test environments comprising executable code which when executed by a processor, causes the processor to perform steps comprising:
receiving one or more test cases from a test management system;
creating one or more test sets by grouping the one or more test cases;
determining a status of each of the plurality of test environments needed for executing each of the one or more test sets; and
rearranging an order of execution of each of the one or more test sets based on the status of each of the plurality of test environments.

18. The medium of claim 17, wherein the determining the status of the test environment corresponding to each of the one or more test sets further comprises:
executing one or more automated instructions in at least one of the plurality of test environments corresponding to each of the one or more test sets; and
determining an execution status of each of the one or more automated instructions based on the execution of the one or more automated instructions, wherein the execution status is one of success and failure.

19. The medium of claim 17, further comprising:
providing highest order of execution for one of the one or more test sets upon determining availability of corresponding test environment; and
providing lowest order of execution for one of the one or more test sets upon determining non-availability of corresponding test environment.

20. The medium of claim 17, further comprising:
determining availability of a virtual response for each of the one or more test sets upon determining non-availability of the test environment for executing each of the one or more test sets; and
providing a virtual service for executing each of the one or more test sets based on the availability of the virtual response.
